(19) United States
(12) Patent Application Publication
(10) Pub. No.: US 2025/0304831 A1
(43) Pub. Date: Oct. 2, 2025

(54) POLYOLEFIN RESIN FOAM, CMP POLISHING FOAM, AND CMP POLISHING FOAM TAPE

(71) Applicant: SEKISUI CHEMICAL CO., LTD., Osaka (JP)

(72) Inventors: Yuuki HOSHIYAMA, Mishimagun Shimamotocho (JP); Kento Sato, Hasuda-shi (JP); Asami Nagai, Hasuda-shi (JP); Hiroaki Koyahara, Hasuda-shi (JP); Hiroki Mikami, Hasuda-shi (JP)

(73) Assignee: SEKISUI CHEMICAL CO., LTD., Osaka (JP)

(21) Appl. No.: 19/078,648

(22) Filed: Mar. 13, 2025

(30) Foreign Application Priority Data
Mar. 28, 2024 (JP) 2024-053946

(51) Int. Cl. C09J 7/26; B24B 57/02; C09J 7/38

(52) U.S. Cl. CPC C09J 7/26; B24B 57/02; C09J 7/38; C09J 2301/302; C09J 2400/243

(57) ABSTRACT

A polyolefin resin foam, a CMP polishing foam and a CMP polishing foam tape are provided, which can not only suppress fluctuations due to vibration during polishing by CMP but also achieve the conformability to projections and depressions on a wafer surface, ensuring the uniformity of the load within the wafer surface during polishing by CMP and improving the flatness of the wafer. A polyolefin resin foam having a 25% compressive strength of 1,350 kPa or more, an expansion ratio of 15 times or less, and a thickness of 2.0 mm or less.

### FIELD OF THE INVENTION

The present invention relates to a polyolefin resin foam, a CMP polishing foam and a CMP polishing foam tape.

### BACKGROUND OF THE INVENTION

In the production process of semiconductor devices, the surface of a wafer having an insulating film, a conductive film, or the like may be polished and flattened by a chemical mechanical polishing (CMP) method. A CMP device to be used in the CMP method has a polishing pad having a multi-layer structure of one or more layers attached on a platen. When the polishing pad has a multi-layer structure, a sub-pad that functions as a cushion layer is attached below a top-pad against which the surface of a wafer is pressed. The CMP device has a polishing head that holds the wafer provided above the platen having the polishing pad. When polishing the wafer, a slurry having ceramics dispersed therein is dropped onto the polishing pad, and the film on the wafer is polished by rotating each of the platen and polishing head while the polishing pad wetted with the slurry is pressed against the wafer.

An improvement in flatness of a wafer has been required for forming a most advanced fine wiring. However, there has been a problem that when a non-expandable rubber or an expandable rubber, or an urethane foam, or the like is used as a sub-pad (see, for example, PTL 1), the compression load during polishing, or the like fluctuates within a wafer surface due to the influence of vibration caused by the rotational motion during polishing, or the like, resulting in variations in polishing rates within the wafer surface.

### CITATION LIST

### Patent Literature

[PTL 1] JP 2004-22886 A

### SUMMARY OF THE INVENTION

### Technical Problem

Accordingly, for solving the above problem, it is an object of the present invention to provide a polyolefin resin foam, a CMP polishing foam and a CMP polishing foam tape which can not only suppress fluctuations due to vibration during polishing by CMP but also achieve the conformability to projections and depressions on a wafer surface, thereby ensuring the uniformity of the load within the wafer surface during polishing by CMP and improving the flatness of the wafer.

### Solution to Problem

The gist of the present invention is the [1] to [9] as follows:
[1]A polyolefin resin foam having a 25% compressive strength of 1,350 kPa or more, an expansion ratio of 15 times or less, and a thickness of 2.0 mm or less.
[2] The polyolefin resin foam according to [1], having a compression set at normal temperature of 10% or more.
[3] The polyolefin resin foam according to [1] or [2], having an aspect ratio expressed as a ratio (MD/ZD) of an average cell diameter in an MD direction to an average cell diameter in a ZD direction being 0.8 to 1.9.
[4] The polyolefin resin foam according to any of [1] to [3], having a degree of crosslinking of 35 to 45% by mass.
[5] The polyolefin resin foam according to any of [1] to [4], wherein the polyolefin resin is a polypropylene resin.
[6] The polyolefin resin foam according to any of [1] to [5], having a ratio of a content of a linear low-density polyethylene resin to a content of a polypropylene resin being 0.1 to 0.4.

[7] The polyolefin resin foam according to any of [1] to [6], having an arithmetic mean height (Sa) of 10 μm or less.

[8]A CMP polishing foam comprising the polyolefin resin foam according to any of [1] to [7].

[9]A CMP polishing foam tape comprising a pressure-sensitive adhesive layer provided on at least one surface of the polyolefin resin foam according to any of [1] to [7].

### Advantageous Effects of Invention

According to the present invention, a polyolefin resin foam, a CMP polishing foam and a CMP polishing foam tape can be provided, which can not only suppress fluctuations due to vibration during polishing by CMP but also achieve the conformability to projections and depressions on a wafer surface, ensuring the uniformity of the load within the wafer surface during polishing by CMP and improving the flatness of the wafer.

### BRIEF DESCRIPTION OF THE DRAWINGS

FIG. 1 is a schematic diagram showing an example of a polishing pad in which the polyolefin resin foam of the present invention is used as a sub-pad.

FIG. 2 is a schematic diagram showing an example of a CMP polishing device provided with a polishing pad in which the polyolefin resin foam of the present invention is used as a sub-pad.

### DETAILED DESCRIPTION OF THE INVENTION

### [Polyolefin Resin Foam]

The polyolefin resin foam of the present invention has a 25% compressive strength of 1,350 kPa or more, an expansion ratio of 15 times or less, and a thickness of 2.0 mm or less.

The polyolefin resin foam of the present invention will be described in detail below as an embodiment.

### (25% Compressive Strength)

The 25% compressive strength of the polyolefin resin foam of the present invention is 1,350 kPa or more. If the 25% compressive strength of the polyolefin resin foam is less than 1,350 kPa, it cannot suppress fluctuations due to vibration during polishing by CMP, making it difficult to ensure the uniformity of the load within a wafer surface during polishing by CMP and failing to enhance the flatness of the wafer. From such a viewpoint, the 25% compressive strength of the polyolefin resin foam is preferably 1,500 kPa or more, more preferably 1,650 kPa or more, and even more preferably 1,800 kPa or more. The upper limit of the range of the 25% compressive strength of the polyolefin resin foam of the present invention is not particularly limited, but it is, for example, 3,500 kPa from the viewpoint of maintaining the conformability to projections and depressions on the wafer surface.

The 25% compressive strength of the polyolefin resin foam can be adjusted by the type, the expansion ratio, or the like of the resin to be used.

The 25% compressive strength of the polyolefin resin foam can be measured by the method described in Examples described below.

### (Expansion Ratio)

The polyolefin resin foam of the present invention has an expansion ratio of 15 times or less. If the expansion ratio of the polyolefin resin foam is more than 15 times, the 25% compressive strength will be reduced, failing to suppress fluctuations due to vibration during polishing by CMP, making it difficult to ensure the uniformity of the load within a wafer surface during polishing by CMP and failing to enhance the flatness of the wafer. From such a viewpoint, the expansion ratio of the polyolefin resin foam is preferably 9 times or less, more preferably 6 times or less, and even more preferably 4 times or less.

The expansion ratio of the polyolefin resin foam may be 1.2 times or more, and it is preferably 1.4 times or more, more preferably 1.6 times or more, even more preferably 1.8 times or more, and still more preferably 2.0 times or more. When the expansion ratio is at a certain level or more, the polyolefin resin foam can be provided with some flexibility and become conformable to projections and depressions on the wafer surface.

The expansion ratio can be determined by the measurement method described in Examples described below.

### (Thickness)

The polyolefin resin foam of the present invention has a thickness of 2.0 mm or less. If the thickness of the polyolefin resin foam is more than 2.0 mm, the deformation rate of the polyolefin resin foam during polishing by CMP increases, failing to suppress fluctuations due to vibration during polishing by CMP, making it difficult to ensure the uniformity of the load within a wafer surface during polishing by CMP, and failing to enhance the flatness of the wafer. From such a viewpoint, the thickness of the polyolefin resin foam is preferably 1.7 mm or less, more preferably 1.4 mm or less, and even more preferably 1.0 mm or less.

The thickness of the polyolefin resin foam may be 0.2 mm or more, and it is preferably 0.4 mm or more, and more preferably 0.6 mm or more. When the thickness of the polyolefin resin foam is at a certain level or more, the polyolefin resin foam can be provided with some flexibility and become conformable to projections and depressions on the wafer surface.

### (Compression Set)

The polyolefin resin foam of the present invention preferably has a compression set at normal temperature of 10% or more, more preferably 12% or more and even more preferably 14% or more. As used herein, the term “normal temperature” refers to a temperature environment of 23° C. If the compression set of the polyolefin resin foam is the above lower limit or less, compression and release are repeated when repeating polishing for a long period of time, but in this case, after release, polishing can be performed from a state close to the previous compressed state when the wafer was polished to suppress the variation in the amount of deformation during compression due to deformation caused by a new compression. Therefore, even when repeating polishing for a long period of time, the uniformity of the load can be ensured, thereby improving the flatness of the wafer.

The compression set at normal temperature of the polyolefin resin foam is preferably 50% or less, more preferably 45% or less, and even more preferably 40% or less. If the compression set of the polyolefin resin foam is the above upper limit or more, the polyolefin resin foam can be provided with some flexibility and room for deformation even when repeating compression and become conformable to projections and depressions on a wafer surface.

The compression set at normal temperature can be determined by the measurement method described in Examples described below.

### (Aspect Ratio)

The ratio (MD/ZD) of the average cell diameter in an MD direction to the average cell diameter in a ZD direction of the polyolefin resin foam of the present invention is preferably 0.8 to 1.9, more preferably 0.9 to 1.8, and even more preferably 1.0 to 1.7. When the MD/ZD is within the above range, the cells are not too flat, the deformation rate of the polyolefin resin foam during polishing by CMP can be reduced to suppress fluctuations due to vibration during polishing by CMP, and ensure the uniformity of the load within a wafer surface during polishing by CMP to enhance the flatness of the wafer.

As used herein, the term “MD” refers to the machine direction and means the direction that corresponds with the extrusion direction or the like of the sheet that forms the polyolefin resin foam. The term “ZD” refers to the thickness direction and means the direction perpendicular to the MD.

### (Average Cell Diameter)

The average cell diameter in the MD direction of the polyolefin resin foam of the present invention is preferably 10 to 500 m, more preferably 25 to 300 m, and even more preferably 50 to 250 m. The average cell diameter in the ZD direction of the polyolefin resin foam of the present invention is preferably 5 to 200 m, more preferably 10 to 150 m, and even more preferably 20 to 100 m. When the average cell diameter in the MD direction of the polyolefin resin foam is within the above range, the polyolefin resin foam can not only suppress fluctuations due to vibration during polishing by CMP but also achieve the conformability to projections and depressions on a wafer surface.

The average cell diameter can be measured according to the method of Examples described below.

### (Degree of Crosslinking (Gel Fraction))

The polyolefin resin foam of the present invention may be a crosslinked polyolefin resin foam, and the degree of crosslinking (gel fraction) of the polyolefin resin foam is preferably 25 to 65% by mass, more preferably 30 to 60% by mass, and even more preferably 35 to 55% by mass. When the degree of crosslinking (gel fraction) is within the above range, the 25% compressive strength can be adjusted to a moderate value.

The degree of crosslinking may be measured by the following measurement method. That is, a test specimen of about 100 mg is taken from the polyolefin resin foam, and the weight A (mg) of the test specimen is precisely weighed. Next, the test specimen is immersed in 30 cm³ of xylene at 120° C. and allowed to stand as it is for 24 hours, followed by filtering it through a 200-mesh wire mesh to collect the insolubles on the wire mesh and drying in a vacuum, and the weight B (mg) of the insolubles is precisely weighed. The degree of crosslinking (% by mass) is calculated from the obtained value according to the following formula:

$$Degree of crosslinking ( \% by mass ) = ( B / A ) \times 100$$

### (Arithmetic Mean Height (Sa))

The arithmetic mean height (Sa) of the surface of the polyolefin resin foam of the present invention is preferably 10 m or less, and more preferably 10 to 8 m. When the arithmetic mean height (Sa) is within the above range, the polyolefin resin foam can have surface smoothness, ensuring the uniformity of the load within a wafer surface during polishing by CMP and improving the flatness of the wafer.

The arithmetic mean height (Sa) can be measured with a commercially available surface property measuring instrument, and can be specifically measured by the method described in Examples.

### <Polyolefin Resin>

The polyolefin resin foam of the present invention is obtained by foaming an expandable composition comprising at least a polyolefin resin. When the polyolefin resin is used, the desired 25% compressive strength of the polyolefin resin foam can be ensured.

Examples of the polyolefin resin include a polypropylene resin and a polyethylene resin. The polyolefin resin to be used is preferably a polypropylene resin from the viewpoint of ensuring the desired 25% compressive strength of the polyolefin resin foam, and more preferably a combination of a polypropylene resin and a polyethylene resin from the viewpoint of ensuring the conformability to projections and depressions on a wafer surface.

### <<Polypropylene Resin>>

The polypropylene resin may be a homopolypropylene, which is a homopolymer of propylene, or a copolymer of propylene and a small amount of a non-propylene α-olefin, which contains propylene as the main component (contains preferably 75% by mass or more, and more preferably 90% by mass or more of propylene, based on the total monomers).

Examples of the copolymer of propylene and a non-propylene α-olefin include a block copolymer, a random copolymer and a random block copolymer, and among these, a random copolymer (that is, a random polypropylene) is preferred.

Examples of the non-propylene α-olefin include 1-butene, 1-pentene, 1-hexene, 4-methyl-1-pentene, 1-hexene, 1-heptene and 1-octene. Among these, an α-olefin having about 4 to 10 carbon atoms is preferred. In the copolymer, these α-olefins can be used alone or in combination of two or more.

The polypropylene resins can be used alone or in combination of two or more.

### <<Polyethylene Resin>>

Examples of the polyethylene resin include a low-density polyethylene resin (having a density of 0.93 g/cm³ or less; LDPE), a medium-density polyethylene resin (having a density of more than 0.930 g/cm³ and less than 0.942 g/cm³; MDPE), and a high-density polyethylene resin (having a density of 0.942 g/cm³ or more; HDPE). Specific examples of a suitable low-density polyethylene resin include a linear low-density polyethylene resin (LLDPE).

From the viewpoint of imparting flexibility, a linear low-density polyethylene resin is preferred as the polyethylene resin. The density of the linear low-density polyethylene resin is preferably 0.90 g/cm³ or more, and more preferably 0.91 g/cm³ or more and 0.93 g/cm³ or less.

The polyethylene resin may be an ethylene homopolymer, or may be a copolymer of ethylene and a small amount of anon-ethylene α-olefin, which contains ethylene as the main component (contains preferably 75% by mass or more, more preferably 90% by mass or more of ethylene, based on the total monomers). The linear low-density polyethylene resin is particularly preferably a copolymer of ethylene and a small amount of anon-ethylene α-olefin, which contains ethylene as the main component. Examples of the non-ethylene α-olefin include one having preferably 3 to 12 carbon atoms and more preferably 4 to 10 carbon atoms, and specific examples thereof include 1-butene, 1-pentene, 1-hexene, 4-methyl-1-pentene, 1-heptene and 1-octene. In the copolymer, these α-olefins can be used alone or in combination of two or more.

The polyethylene resins may be used alone or in combination of two or more.

The polyolefin resin to be used may be any of a polypropylene resin, a polyethylene resin or a mixture thereof obtained by polymerization with a polymerization catalyst such as a Ziegler-Natta compound, a metallocene compound or a chromium oxide compound. Among these, the use of a polyethylene resin, particularly a linear low-density polyethylene, obtained by polymerization with a metallocene compound polymerization catalyst makes it easier to obtain a polyolefin resin foam having a moderate flexibility.

### <<Content of Each Resin>>

When a polypropylene resin is used as the polyolefin resin, the content of the polypropylene resin based on the total amount of resin contained in the polyolefin resin foam is, for example, 50% by mass or more, preferably 60% by mass or more, and more preferably 70% by mass or more. The polypropylene resin in the polyolefin resin foam may be used alone as a resin component. The content of the polypropylene resin may be 100% by mass or less, but it is preferably 90% by mass or less, and more preferably 85% by mass or less.

The polypropylene resin preferably comprises a homopolypropylene from the viewpoint of making the foam rigid, thereby suppress fluctuations due to vibration during polishing by CMP, and a homopolypropylene and a random polypropylene are also preferably used in combination. When they are used in combination, the ratio by mass of the content of the homopolypropylene to the content of the random polypropylene is preferably 0.3 to 0.9, more preferably 0.4 to 0.8, and even more preferably 0.5 to 0.7.

When a polyethylene resin is used as the polyolefin resin, the content of the polyethylene resin based on the total amount of resin contained in the polyolefin resin foam is preferably 50% by mass or less, more preferably 40% by mass or less, and even more preferably 30% by mass or less. The foam may contain no polyethylene resin, and the content of the polyethylene resin may be 0% by mass or more, but it is preferably 10% by mass or more, and more preferably 15% by mass or more.

When a linear low-density polyethylene resin is used as the polyethylene resin, the ratio of the content of the linear low-density polyethylene resin to the content of the polypropylene resin is preferably 0.1 to 0.4, more preferably 0.15 to 0.35, and even more preferably 0.2 to 0.3.

### <<Non-Polyolefin Resins>>

Polyolefin resin foam may be produced by using a non-polypropylene resin or a non-polyethylene resin as the polyolefin resin, and examples thereof include various types of ethylene propylene-based thermoplastic elastomers such as EPDM. The polyolefin resin may be used in combination with a non-polyolefin resin, and examples of the non-polyolefin resin include a styrene-based thermoplastic elastomer and a rubber component.

When the polyolefin resin foam contains a resin (the other resin) other than the polypropylene resin and the polyethylene resin, the percentage of the other resin based on the total amount of resins in the polyolefin resin foam is preferably 20% by mass or less, more preferably 10% by mass or less, and even more preferably 0% by mass.

### <Foaming Agent>

The polyolefin resin foam of the present invention may be obtained by foaming a polyolefin resin composition (hereinafter, sometimes simply referred to as “resin composition”) that comprises a polyolefin resin and a foaming agent. The resin composition may also appropriately contain additives described later in addition to the polyolefin resin and the foaming agent.

The foaming agent is preferably a foaming agent that foams the resin composition by generating gas when heated, and specifically, a thermally decomposable foaming agent is preferred. The thermally decomposable foaming agent that can be used is an organic foaming agent or an inorganic foaming agent. Examples of the organic foaming agent include an azo compound such as azodicarbonamide, a metal azodicarboxylate (such as barium azodicarboxylate) or azobis(isobutyronitrile); a nitroso compound such as N,N′-dinitrosopentamethylenetetramine; a hydrazine derivative such as hydrazodicarbonamide, 4,4′-oxybis(benzenesulfonylhydrazide) or toluenesulfonyl hydrazide, and a semicarbazide compound such as toluenesulfonyl semicarbazide.

Examples of the inorganic foaming agent include ammonium carbonate, sodium carbonate, ammonium hydrogen carbonate, sodium hydrogen carbonate, ammonium nitrite, sodium borohydride, and anhydrous monosodium citrate.

Among these, an azo compound is preferred, and azodicarbonamide is more preferred, from the viewpoint of obtaining fine cells and from the viewpoint of economy and safety.

The foaming agents may be used alone or in combination of two or more.

The amount of the foaming agent to be blended into the resin composition is preferably 0.5 to 5 parts by mass, more preferably 1.0 to 4 parts by mass, and even more preferably 1.5 to 3 parts by mass, based on 100 parts by mass of the polyolefin resin. When the amount of foaming agent to be blended is within the above range, excessive foaming is prevented, and a polyolefin resin foam with the desired expansion ratio can be obtained.

### <Additives>

The polyolefin resin foam may contain, for example, a crosslinking aid as an additive. A multifunctional monomer can be used as the crosslinking aid. By adding the crosslinking aid to the polyolefin resin, the dose of the ionizing radiation to be irradiated during crosslinking is reduced, thereby preventing the cleavage and degradation of resin molecules caused by irradiation with the ionizing radiation.

Specific examples of the crosslinking aid include a compound having three functional groups in one molecule, such as trimethylolpropane trimethacrylate, trimethylolpropane triacrylate, triallyl trimellitate, triallyl 1,2,4-benzenetricarboxylate or triallyl isocyanurate; a compound having two functional groups in one molecule, such as 1,6-hexanediol dimethacrylate, 1,9-nonanediol dimethacrylate, 1,10-decanediol dimethacrylate or divinylbenzene; diallyl phthalate, diallyl terephthalate, diallyl isophthalate, ethylvinylbenzene, neopentyl glycol dimethacrylate, lauryl methacrylate, and stearyl methacrylate.

These crosslinking aids are used alone or in combination of two or more.

The amount of the crosslinking aid to be blended is preferably 0.5 to 10 parts by mass, more preferably 1.0 to 8 parts by mass, and even more preferably 1.5 to 5 parts by mass, based on 100 parts by mass of the polyolefin resin. When the amount of the crosslinking aid to be blended is within the above range, the degree of crosslinking can be easily controlled to stably obtain the desired degree of crosslinking.

The polyolefin resin foam may contain, for example, an antioxidant as an additive. Examples of the antioxidant include a phenolic antioxidant such as tetrakis[methylene-3-(3,5-di-tert-butyl-4-hydroxyphenyl)propionate]methane or 2,6-di-t-butyl-p-cresol; a sulfur antioxidant such as dilauryl thiodipropionate; a phosphorus antioxidant; and an amine antioxidant.

The amount of the antioxidant to be blended is, for example, 0.01 to 5 parts by mass, based on 100 parts by mass of the polyolefin resin.

### <Other Additives>

The foam may be blended with an additive other than a crosslinking aid and an antioxidant, and may be blended with an additive commonly used in a foam, such as a decomposition temperature regulator, a thermal stabilizer, a coloring agent, an antistatic agent or a filler.

### <Method of Producing Foam>

The polyolefin resin foam of the present invention can be obtained by foaming a resin composition comprising a polyolefin resin and a foaming agent. If necessary, it may be foamed after crosslinking. The method of producing a polyolefin resin foam will be described in detail below.

The method of producing a polyolefin resin foam according to a preferred embodiment of the present invention comprises the following steps 1 and 2:
step 1: mixing a polyolefin resin, a foaming agent, and an additive to be added as necessary to obtain a resin composition, and forming the obtained resin composition into a sheet; and
step 2: foaming the sheet-shaped resin composition obtained in step 1 to obtain a foam.

### (Step 1)

Step 1 is not particularly limited, but it is preferably carried out, for example, with an extruder. When an extruder is used, step 1 may be carried out by supplying a polyolefin resin, a foaming agent and an additive to be blended as necessary to the extruder, melt-kneading these components and extruding them from the extruder to obtain a sheet-shaped resin composition. Melt-kneading may be carried out with a mixing apparatus other than an extruder. Forming of the resin composition may be carried out by means other than extrusion, and the resin composition may be formed into a sheet by pressing or the like.

The temperature during melt-kneading may be a temperature at which the foaming agent does not foam and at which each component can be mixed. For example, when the foaming agent is a thermally decomposable foaming agent, melt-kneading may be carried out at a temperature below the decomposition temperature of the thermally decomposable foaming agent.

When crosslinking the resin composition obtained in step 1, examples of the crosslinking method include a method of irradiating the resin composition with ionizing radiation such as electron beams, α-rays, β-rays or γ-rays, and a method of blending an organic peroxide into the resin composition in advance and heating the resin composition to decompose the organic peroxide. These methods may be used in combination. Among these, the method of irradiating the resin composition with ionizing radiation is preferred. The dose of the ionizing radiation to be irradiated is preferably 0.5 to 20 Mrad, and more preferably 1.0 to 12 Mrad.

Examples of the organic peroxide to be used for crosslinking include 1,1-bis(t-butylperoxy)-3,3,5-trimethylcyclohexane and 1,1-bis(t-butylperoxy)cyclohexane. These may be used alone or in combination of two or more. The amount of the organic peroxide to be added is preferably 0.01 to 5 parts by mass and more preferably 0.1 to 3 parts by mass, based on 100 parts by mass of the polyolefin resin. When the amount of the organic peroxide to be added is within the above range, crosslinking of the resin composition can easily progress and the amount of the decomposition residue of the organic peroxide in the resulting foam can be suppressed. The organic peroxide may be mixed into the polyolefin resin in step 1, similar to the other additives.

### (Step 2)

Step 2 is not particularly limited as long as in step 2, the sheet-shaped resin composition can be foamed, but the resin composition is preferably foamed by heating it.

The method of heating the resin composition is not particularly limited. Examples thereof include a method of heating the resin composition with hot air; a method of heating the resin composition with infrared rays; a method of heating the resin composition in a salt bath; and a method of heating the resin composition in an oil bath, and these may be used in combination.

The heating temperature during foaming in step 2 is not particularly limited, but when a thermally decomposable foaming agent is used, the temperature may be a temperature of not less than the decomposition temperature of the thermally decomposable foaming agent, and it is, for example, 200 to 300° C. and preferably 220 to 280° C.

The polyolefin resin foam may or may not be stretched in step 2. The stretching may be carried out after the resin composition is foamed to obtain the polyolefin resin foam, or may be performed while the resin composition is foamed.

The polyolefin resin foam obtained above may be cut by any known method to appropriately adjust the contour shape and formed as a sub-pad for a polishing pad.

The obtained polyolefin resin foam can be sliced to obtain a foam having a desired thickness, but in order to adjust it to satisfy the above-described arithmetic mean height (Sa) of the surface, it is preferable not to slice it to leave the skin layer.

The method of producing a polyolefin resin foam described above is one example, and the polyolefin resin foam of the present invention may be produced by any method other than the method described above.

### <Uses>

The polyolefin resin foam of the present invention may be used, for example, as a CMP polishing foam. Specifically, the polyolefin resin foam of the present invention can be used as a sub-pad provided under a top-pad of a polishing pad, having a multi-layer structure, to be used in polishing by CMP.

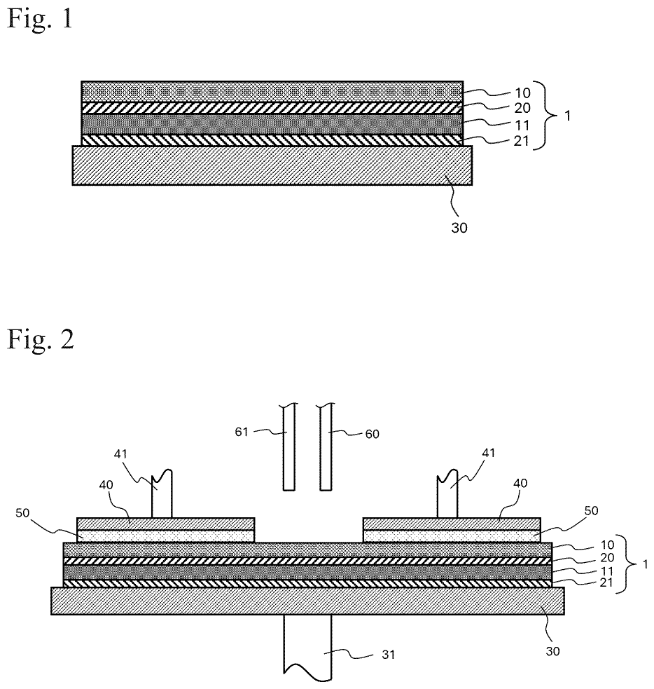

As shown in FIG. 1, a polishing pad 1 comprising the polyolefin resin foam of the present invention as a sub-pad comprises two layers, a top-pad 10 and the sub-pad 11. The top-pad 10 is pressed against an object to be polished during polishing by CMP and has the function of polishing the object to be polished. The sub-pad 11 functions as a cushion layer for uniformly pressing the top-pad 10 against the polished surface of the object to be polished in polishing by CMP. The polishing pad 1 further comprises a first pressure-sensitive adhesive layer 20 that bonds the top-pad 10 and the sub-pad 11, and a second pressure-sensitive adhesive layer 21 that bonds the sub-pad 11 and a platen 30.

The top-pad 10 may be made of any abrasive material capable of uniformly polishing the surface of a wafer, which is the object to be polished. Examples of the abrasive material include hard urethane, suede, or nonwoven fabric impregnated with urethane.

The sub-pad 11 to be used may be made of the polyolefin resin foam of the present invention. The use of the polyolefin resin foam of the present invention can prevent the compression load or the like during polishing from fluctuating within the surface of the wafer, which is the object to be polished, due to the influence of for example, vibration caused by the rotational motion during polishing, and can thereby suppress variations in the polishing rate within the wafer surface.

As shown in FIG. 2, the CMP polishing device comprises a polishing head 40 above a platen 30 on which a polishing pad 1 is placed. The polishing head 40 is capable of holding a wafer 50 and is provided with a pressurizing mechanism (not shown), such as a multi-zone type pressurizing chamber, which can press the wafer 50 against the polishing pad 1 (a top-pad 10) at a predetermined pressure. The polishing head 40 is rotatably supported by a rotating shaft 41. The rotating shaft 41 of the polishing head 40 is disposed parallel to a rotating shaft 31 of the platen 30. In addition, the polishing head 40 is supported above the platen 30 so that it can reciprocate between the center in the radial direction and the outside in the radial direction.

Furthermore, the platen 30 has provided thereabove slurry piping 60 that supplies a slurry onto the polishing pad 1 and a cleaning piping 61 that can supply ultrapure water onto the polishing pad 1 for cleaning or the like.

A summary of polishing by CMP of a wafer with reference to the CMP polishing device shown in FIG. 2 will be now described.

Next, the polishing head 40 holding the wafer 50, which is the object to be polished, is disposed on the polishing pad 1 (top-pad 10), and each of the platen 30 and the polishing head 40 is rotated while the slurry is supplied from the slurry piping 60. This causes the polishing pad 1 (top-pad 10) and the wafer 50 to rub against each other through the abrasive grains of the slurry, generating heat. As a result, the temperature of the interface between the wafer 50 and the polishing pad 1 (top-pad 10) rises, and chemical mechanical polishing progresses.

When the chemical reaction starts, the heat generated by the chemical reaction is also superimposed, accelerating the rate of temperature rise. Before long, a steady state is reached, and polishing at a constant speed starts.

When polishing is completed, the polishing head 40 is raised and ultrapure water is supplied from cleaning piping 61 to the polishing pad 1 (top-pad 10) to remove any polishing residues on the surface of the wafer 50 that are present on the polishing pad 1 (top-pad 10).

In the above-described polishing pad 1, the polyolefin resin foam of the present invention as the sub-pad 11 is configured to have a first pressure-sensitive adhesive layer 20 and a second pressure-sensitive adhesive layer 21 provided separately thereon, but the polyolefin resin foam may be given in a CMP polishing foam tape having a pressure-sensitive adhesive layer provided on at least one surface. The CMP polishing foam tape having a pressure-sensitive adhesive layer provided on at least one surface of the polyolefin resin foam can be easily bonded to the top-pad 10 or platen 30 which is the object to be bonded.

The pressure-sensitive adhesive layer used for each of the first pressure-sensitive adhesive layer 20 and the second pressure-sensitive adhesive layer 21 are not particularly limited as long as it can be bonded to the top-pad 10 or platen 30 which is the object to be bonded, and it may be, for example, a single pressure-sensitive adhesive layer made of an adhesive, or a double-sided adhesive tape having a substrate and pressure-sensitive adhesive layers provided on both sides of the substrate. The adhesive that can be used may be an acrylic-based pressure-sensitive adhesive, a urethane-based pressure-sensitive adhesive, a rubber-based pressure-sensitive adhesive, a silicone-based pressure-sensitive adhesive, or the like. The pressure-sensitive adhesive used for the first pressure-sensitive adhesive layer 20 may be an pressure-sensitive adhesive that is resistant to the slurry used in polishing by CMP, and preferably a rubber-based pressure-sensitive adhesive. The pressure-sensitive adhesive used for the second pressure-sensitive adhesive layer 21 may be preferably an acrylic-based pressure-sensitive adhesive.

### Examples

The present invention will be described in detail with reference to Examples, but the present invention will not be limited to these Examples in any way.

The method for measuring each of the physical properties and the methods for evaluating the foam are as follows.

### <25% Compressive Strength>

The 25% compressive strength of the foam in each of Examples and Comparative Examples was measured at 23° C. in accordance with JIS K6767.

### <Expansion Ratio>

The expansion ratio was calculated by measuring the specific volume (unit: cm³/g) of each of the resin composition before foaming and the foam obtained after foaming, and calculating it by (the specific volume of the foam)/(the specific volume of the resin composition before foaming).

### <Thickness>

The thickness of the foam in each of Examples and Comparative Examples was measured with a dial gauge indicator.

### <Average Cell Diameter>

The foam in each of Examples and Comparative Examples was cut into 50 mm squares, immersed in liquid nitrogen for 1 minute, and then cut in the thickness direction along the MD direction, and photographed at 200 times magnification with a digital microscope (product name VHX-900; manufactured by Keyence Corporation). For the foam in the photographed image, the cell diameters in the MD direction were measured for 50 cells present on the cut surface in the MD direction, and the average value was determined as the average cell diameter in the MD direction.

### <Compression Set>

The central thickness of the foam in each of Examples and Comparative Examples was measured at normal temperature (23° C.) (t0).

The foam in each of Examples and Comparative Examples was placed on a compression plate (smooth stainless-steel plate), and spacers having a height of t1 which was the height when the foam was compressed to 25% were placed on both sides of the foam. Another compression plate was then placed on top of the foam. At this time, the foam and spacers were sandwiched between the two compression plates.

The foam sandwiched between the two compression plates was placed in a compression apparatus (compression set tester, manufactured by M&K Co., Ltd.).

The compression apparatus was then used to compress the foam until the spacers came into contact with the upper and lower compression plates. This caused the foam to be compressed to 25%. Since the spacers are not compressed, they prevent the foam from being compressed beyond 25%.

The compression apparatus, containing the foam which was compressed by it, was placed in a thermostatic chamber the temperature of which was adjusted to normal temperature. The time at this point was used as the start time of the test. Twenty-two hours after the start of the test, the compression apparatus was removed from the thermostatic chamber, and the foam was removed from the compression apparatus. The removed foam was allowed to stand in the test chamber under standard conditions of normal temperature and standard atmospheric pressure of 1 atm for 24 hours, and the thickness of the foam at the center (t2) was then measured. The compression set (Cs) was then calculated according to the following formula (1).

$$Cs = ( t 2 - t 0 ) / ( t 1 - t 0 ) \times 100 \qquad ( 1 )$$

### <Aspect Ratio>

A piece obtained by cutting the foam into 50 mm squares is prepared as a foam sample for measurement. This is immersed in liquid nitrogen for 1 minute and then cut in the thickness direction along the MD direction and the TD direction, respectively with a razor blade. Each cross section is photographed at 200 times magnification with a digital microscope (product name VHX-900; manufactured by Keyence Corporation), and the cell diameters of all cells present on the cut surface of 2 mm length portion in both the MD and ZD directions are measured, and this operation is repeated five times. The average values of the cell diameters of all cells were then calculated as the average cell diameters in the MD and ZD directions.

The ratio (MD/ZD) of the average cell diameter in the MD direction to the average cell diameter in the ZD direction was then calculated from the calculated average cell diameters in the MD and ZD directions.

### <Degree of Crosslinking (Gel Fraction)>

The degree of crosslinking (gel fraction) of the foam was measured by the method described in the present specification.

### <Arithmetic Mean Height (Sa)>

This was determined by the analysis of the surface properties with a laser microscope (VK-X150, manufactured by Keyence Corporation), in accordance with ISO 25178. Specifically, the surface profile of a two-dimensional area having a surface area of 1,000 μm×1,000 μm was measured at a lens magnification of 10 times by a laser method. Measurements were taken at three locations on the same foam sample, and the average of the measurements was determined as the arithmetic mean height (Sa).

### <Evaluation of Deformation Stability>

A piece obtained by cutting the foam obtained in each of Examples and Comparative Examples into 25 mm squares is prepared as a foam sample for measurement. A load of 1,000 kPa was applied to the foam sample in the thickness direction, the thickness of the foam sample after the load was applied was measured, and the deformation amount of the thickness of the foam sample and the deformation rate of the thickness of the foam sample between before and after the load was applied were calculated. The deformation stability was evaluated according to the following evaluation criteria.
A: Deformation rate of the thickness of the sample of less than 1%
B: Deformation rate of the thickness of the sample of 1% or more

### <Evaluation of Pressure Sensitive Paper>

A piece obtained by cutting the foam obtained in each of Examples and Comparative Examples into a cylindrical shape with a diameter of 10 mm is prepared as a foam sample for measurement. The foam sample was placed on a pressure sensitive paper (Prescale for ultra-low pressure, model: LLLW; manufactured by FUJIFILM Corporation), a load of 4,000 N was applied in the thickness direction of the foam sample, and the color change of the pressure sensitive paper after the load was applied was measured, and evaluated according to the following evaluation criteria. The pressure sensitive paper is originally white, and the area to which the pressure is applied changes to red.
A: White color of 5% or less
B: White color of more than 5%

### <Evaluation of Repeated Compressibility>

A piece obtained by cutting the foam obtained in each of Examples and Comparative Examples into 25 mm squares is prepared as a foam sample for measurement. A load of 40 kPa was applied to the foam sample in the thickness direction five times, the thickness of the foam sample after the fifth load was applied was measured, and the deformation amount of the thickness of the foam sample and the deformation rate of the thickness of the foam sample between before and after the load was applied were calculated. The repeated compressibility was evaluated according to the following evaluation criteria.
A: Deformation rate of the thickness of sample of 1% or less
B: Deformation rate of the thickness of sample of 1% or more

### <Raw Materials Used>

The materials used in Examples and Comparative Examples are as follows.

### (Resin)

Homopolypropylene (trade name “J106G”; MFR=15 g/10 min (230° C.); manufactured by Prime Polymer Co., Ltd.)
Random polypropylene (trade name “AD571”; MFR=0.5 g/10 min (230° C.); manufactured by SUMITOMO CHEMICAL COMPANY, LIMITED)
Random polypropylene: (trade name “E222”; density: 0.90 g/cm³; MFR=1.5 g/10 min (230° C.); manufactured by Prime Polymer Co., Ltd.)
Linear low-density polyethylene (LLDPE) (trade name “ULTZEX 1020L”; density: 0.91 g/cm³; MFR=2.0 g/10 min (190° C.); manufactured by Prime Polymer Co., Ltd.)
Low-density polyethylene (LDPE) (trade name “G215”; density; 0.92 g/cm³; MFR=1.4 g/10 min (190° C.); manufactured by SUMITOMO CHEMICAL COMPANY, LIMITED)
Low-density polyethylene (LDPE) (trade name “G201”; density: 0.919 g/cm³; MFR=2.0 g/10 min (190° C.); manufactured by SUMITOMO CHEMICAL COMPANY, LIMITED)

### (Foaming Agent)

Azodicarbonamide (thermally decomposable foaming agent; trade name “SOL”; decomposition temperature: 197° C.; average particle size: 3.2 μm; manufactured by Otsuka Chemical Co., Ltd.)

### (Crosslinking Aid)

1,9-Nonanediol dimethacrylate (trade name “Light Ester 1.9-ND”; viscosity:8 mPa s (25° C.); manufactured by Kyoeisha Chemical Co., Ltd.)

### (Antioxidant)

Phenolic antioxidant (trade name “Irganox 1010”, tetrakis[methylene-3-(3,5-di-tert-butyl-4-hydroxyphenyl)propionate]methane; manufactured by BASF Japan Ltd.)

### Example 1

Thirty parts by mass of a homopolypropylene (J106G), 50 parts by mass of a random polypropylene (AD571), 20 parts by mass of an LLDPE (ULTZEX 1020L), 4 parts by mass of a crosslinking aid, 2.3 parts by mass of a foaming agent and 1 part by mass of an antioxidant were kneaded in a plastomill, and then subjected to hot pressing to obtain a sheet-shaped resin composition having a thickness of 0.7 mm.

Subsequently, the sheet-shaped resin composition was irradiated at both sides thereof with an electron beam of 2.5 Mrad at an acceleration voltage of 800 kV to crosslink it, and then foamed by heating it in a hot air oven set at 270° C. for 3 minutes to obtain a foam. The evaluation results of the obtained foam are shown in Table 1.

### Example 2 to 4

The procedure of each of Examples 2 to 4 was carried out in the same manner as that of Example 1, except that the amount of the foaming agent to be blended was changed and the expansion ratio was changed as shown in Table 1.

### Comparative Examples 1 to 3

The procedure of each of Comparative Examples 1 to 3 was carried out in the same manner as that of Example 1, except that the amount of the foaming agent to be blended was changed and the expansion ratio was changed as shown in Table 1.

TABLE 1

| | | | | | | | Compar- | Compar- | Compar- |
|---|---|---|---|---|---|---|---|---|---|
| | | | | | | | ative | ative | ative |
| | | | Example | Example | Example | Example | Example | Example | Example |
| | | | 1 | 2 | 3 | 4 | 1 | 2 | 3 |
| Composition | Resin | J106G (homo PP) | 30 | 30 | 30 | | | | 30 |
| (parts by | | AD571 (random PP) | 50 | 50 | 50 | 30 | | 30 | 50 |
| mass) | | E222 (random PP) | | | | 50 | | 50 | |
| | | ULTZEX (LLDPE) | 20 | 20 | 20 | 20 | | 20 | 20 |
| | | G215 (LDPE) | | | | | 50 | | |
| | | G201 (LDPE) | | | | | 50 | | |
| | Crosslinking | Light ester 1,9-ND | 4 | 4 | 4 | 4 | | 4 | 4 |
| | aid | | | | | | | | |
| | Foaming | SOL | 2.3 | 2.1 | 1.7 | 2.2 | 2.4 | 2.4 | 2.3 |
| | agent | | | | | | | | |
| | Antioxidant | Irganox 1010 | 1 | 1 | 1 | 1 | 1 | 1 | 1 |

| Performance | Thickness [mm] | | 0.8 | 0.8 | 0.8 | 0.8 | 0.8 | 0.8 | 0.8 |
|---|---|---|---|---|---|---|---|---|---|
| | Expansion ratio [times] | | 4.0 | 3.0 | 2.0 | 4.0 | 5.0 | 5.0 | 4.0 |
| | Aspect ratio [—] | | 0.9 | 1.2 | 1.6 | 1.1 | 1.1 | 1.2 | 2 |
| | 25% Compressive strength [kPa] | | 1,823 | 2,186 | 3,392 | 1,563 | 250 | 884 | 540 |
| | Average cell diameter [μm] | | 112 | 87 | 115 | 94 | 126 | 107 | 200 |
| | Compression set [%] | | 14.8 | 15.7 | 16.1 | 13.9 | 2.2 | 4.6 | 3.7 |
| | Gel fraction [%] | | 38 | 42 | 43 | 40 | 25 | 39 | 38 |
| | Arithmetic mean height (Sa) | | 9.0 | 8.8 | 8.5 | 9.7 | 14.3 | 12.5 | 10.8 |
| Evaluation | Evaluation of | Deformation | 0.006 | 0.005 | 0.003 | 0.007 | 0.017 | 0.013 | 0.015 |
| | deformation | amount [mm] | | | | | | | |
| | stability | Deformation | 0.75% | 0.63% | 0.38% | 0.88% | 2.13% | 1.63% | 1.88% |
| | | rate [%] | | | | | | | |
| | | Evaluation | A | A | A | A | B | B | B |
| | Evaluation | Rate of white | 4.4% | 4.2% | 3.7% | 4.8% | 6.5% | 5.4% | 5.8% |
| | of pressure | color [%] | | | | | | | |
| | sensitive | Evaluation | A | A | A | A | B | B | B |
| | paper | | | | | | | | |
| | Evaluation | Deformation | 0.004 | 0.003 | 0.002 | 0.005 | 0.013 | 0.009 | 0.011 |
| | of repeated | amount [mm] | | | | | | | |
| | compress- | Deformation | 0.50% | 0.38% | 0.25% | 0.63% | 1.63% | 1.13% | 1.38% |
| | ibility | rate [%] | | | | | | | |
| | | Evaluation | A | A | A | A | B | B | B |

When the foam of each of Examples, which had a specific compressive strength and expansion ratio, was used as a sub-pad for a CMP polishing pad, it could not only suppress fluctuations due to vibration during polishing by CMP but also achieve the conformability to projections and depressions on a wafer surface, ensuring the uniformity of the load within the wafer surface during polishing by CMP and improving the flatness of the wafer. By contrast, when the foam of each of Comparative Examples was used as a sub-pad for a CMP polishing pad, it was difficult to suppress fluctuations due to vibration during polishing by CMIP, the conformability to projections and depressions on the wafer surface was insufficient, the uniformity of the load within the wafer surface during polishing by CMP was not achieved, and the wafer was thicker at the edge portion than at the center portion.

### REFERENCE SIGNS LIST

1 . . . Polishing pad
10 . . . Top-pad
11 . . . Sub-pad
20 . . . First pressure-sensitive adhesive layer
21 . . . Second pressure-sensitive adhesive layer
30 . . . Platen
31 . . . Rotating shaft
40 . . . Polishing head
41 . . . Rotating shaft
50 . . . Wafer
60 . . . Slurry piping
61 . . . Cleaning piping

1. A polyolefin resin foam having a 25% compressive strength of 1,350 kPa or more, an expansion ratio of 15 times or less, and a thickness of 2.0 mm or less.

2. The polyolefin resin foam according to claim 1, having a compression set at normal temperature of 10% or more.

3. The polyolefin resin foam according to claim 1, having an aspect ratio expressed as a ratio (MD/ZD) of an average cell diameter in an MD direction to an average cell diameter in a ZD direction being 0.8 to 1.9.

4. The polyolefin resin foam according to claim 1, having a degree of crosslinking of 35 to 45% by mass.

5. The polyolefin resin foam according to claim 1, wherein the polyolefin resin is a polypropylene resin.

6. The polyolefin resin foam according to claim 1, having a ratio of a content of a linear low-density polyethylene resin to a content of a polypropylene resin being 0.1 to 0.4.

7. The polyolefin resin foam according to claim 1, having an arithmetic mean height (Sa) of 10 μm or less.

8. A CMP polishing foam comprising the polyolefin resin foam according to claim 1.

9. A CMP polishing foam tape comprising a pressure-sensitive adhesive layer provided on at least one surface of the polyolefin resin foam according to claim 1.
